(19) United States
(12) Patent Application Publication
(10) Pub. No.: US 2025/0117502 A1
(43) Pub. Date: Apr. 10, 2025

(54) SYSTEMS AND METHODS FOR SECURING CONTENT

(71) Applicant: Capital One Services, LLC, McLean, VA (US)

(72) Inventors: Matthew HUNSBERGER, Hoboken, NJ (US); Ermenildo CASTRO, Tacoma, WA (US); Shahalam BAIG, Rochester, NY (US); Jackson WESTWOOD, New York, NY (US); Hyunwoo KANG, New York, NY (US); Shasanka BHANDARI, McLean, VA (US)

(73) Assignee: Capital One Services, LLC, McLean, VA (US)

(21) Appl. No.: 18/905,179

(22) Filed: Oct. 3, 2024

Related U.S. Application Data
(60) Provisional application No. 63/587,891, filed on Oct. 4, 2023.
(60) Provisional application No. 63/665,485, filed on Jun. 28, 2024.
(60) Provisional application No. 63/683,063, filed on Aug. 14, 2024.

(51) Int. Cl. G06F 21/60

(52) U.S. Cl. CPC G06F 21/602

(57) ABSTRACT

A method may include receiving, using an application server, formatting information that is associated with sensitive information, from a computing device. The method may include generating, using the application server and based on the formatting information, a video including a single image frame. The single image frame may represent the sensitive information, and the video may be associated with a digital rights management technology. The method may further include transmitting, using the application server, the video to the computing device.

### CROSS-REFERENCE TO RELATED APPLICATION(S)

This application claims the benefit of pending U.S. Provisional Patent Application No. 63/587,891, filed on Oct. 4, 2023, and claims the benefit of pending U.S. Provisional Patent Application No. 63/665,485, filed on Jun. 28, 2024, and claims the benefit of pending U.S. Provisional Patent Application No. 63/683,063, filed Aug. 14, 2024, each of which is incorporated herein by reference in its entirety.

### TECHNICAL FIELD

Various embodiments of this disclosure relate generally to techniques for

securing content, and more particularly to systems and methods for securing content of a portal (e.g., a webpage, a website, an application, or the like).

### BACKGROUND

Organizations such as banks and healthcare providers seek to protect sensitive information (e.g., confidential information, personally identifiable information, financial information, medical information, etc.) from social engineers. A social engineer is a person or entity who seeks to manipulate a target (e.g., a customer or employee of an organization) into divulging sensitive information that may be used for fraudulent purposes. That is, a social engineer is a person or entity who engages in social engineering. For example, when the target is a user who uses a display screen (also referred to herein as a “screen”) of a computing device to view an account number on a bank's website, a social engineer using another computing device may persuade the user to reveal the account number to the social engineer. More specifically, the social engineer may convince the user to share the user's screen displaying the account number with the social engineer, using a screensharing or remote desktop application. In addition or in the alternative, the social engineer may convince the user to take a screenshot of the user's screen displaying the account number, using a screenshotting application, and to then transmit the screenshot to the social engineer.

To guard against such social engineering, the bank may wish to employ a technology that limits the use of digital content provided on the bank's website. While digital management (“DRM”) technologies may limit the use of digital content, such technologies are often configured to protect digital videos (e.g., of movies or shows), rather than static content such as bank account numbers or a customer's name or address.

This disclosure is directed to addressing one or more of the above-referenced challenges. The background description provided herein is for the purpose of generally presenting the context of the disclosure. Unless otherwise indicated herein, the materials described in this section are not prior art to the claims in this application and are not admitted to be prior art, or suggestions of the prior art, by inclusion in this section.

### SUMMARY OF THE DISCLOSURE

According to certain aspects of the disclosure, systems and methods for securing content of a portal (e.g., a webpage, a website, an application, or the like) are disclosed. Each of the examples disclosed herein may include one or more features described in connection with any of the other disclosed examples.

In one aspect, an exemplary embodiment of a method may include receiving, using an application server, formatting information that is associated with sensitive information, from a computing device. The method may include generating, using the application server and based on the formatting information, a video including a single image frame, where the single image frame represents the sensitive information, and where the video is associated with a digital rights management technology. The method may further include transmitting, using the application server, the video to the computing device.

In a further aspect, an exemplary embodiment of a system may include at least one processor and at least one memory having programming instructions stored thereon, which, when executed by the at least one processor, cause the system to perform operations. The operations may include receiving, using an application server, formatting information that is associated with sensitive information. The operations may include generating, using the application server and based on the formatting information, a video including a single image frame, where the single image frame represents the sensitive information, and where the video is associated with a digital rights management technology. The operations may further include transmitting, using the application server, the video to a computing device.

In another aspect, an exemplary embodiment of a method may include receiving, using an application server, formatting information that is associated with sensitive information, via an application programming interface and from a computing device. The method may include generating, using the application server and based on the formatting information, a video including a single image frame, where the single image frame represents the sensitive information, and where the video is associated with a digital rights management technology. The method may include transmitting, using the application server, the video to the computing device.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 depicts an example environment, according to one or more embodiments.

FIG. 2 depicts a flowchart of an example method, according to one or more embodiments.

FIG. 3 depicts a flowchart of an example method, according to one or more embodiments.

FIG. 4 depicts a flowchart of an example method, according to one or more embodiments.

FIG. 5 depicts an example computing device, according to one or more embodiments.

### DETAILED DESCRIPTION OF EMBODIMENTS

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section. Both the foregoing general description and the following detailed description are exemplary and explanatory only and are not restrictive of the features, as claimed.

In this disclosure, the term “based on” means “based at least in part on.” The singular forms “a,” “an,” and “the” include plural referents unless the context dictates otherwise. The term “exemplary” is used in the sense of “example” rather than “ideal.” The terms “comprises,” “comprising,” “includes,” “including,” or other variations thereof, are intended to cover a non-exclusive inclusion such that a process, method, or product that comprises a list of elements does not necessarily include only those elements, but may include other elements not expressly listed or inherent to such a process, method, article, or apparatus. The term “or” is used disjunctively, such that “at least one of A or B” includes, (A), (B), (A and A), (A and B), etc. Relative terms, such as, “substantially,” “approximately,” “about,” and “generally,” are used to indicate a possible variation of ±10% of a stated or understood value.

It will also be understood that, although the terms first, second, third, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

As used herein, the term “screenshare” may refer to a real time or near real time electronic transmission of data displayed on a display screen of a user's computing device to one or more other computing devices. The term “screensharing” and the phrase “being screenshared” may refer to performing a screenshare. In some aspects, screensharing may be performed using a screensharing application (e.g., a video or web conferencing application such as Zoom®, Microsoft's Teams®, or the like, or a remote desktop application such as Microsoft Remote Desktop, Chrome Remote Desktop, or the like). As used herein, the term “screenshot” may represent an image of data displayed on a display screen of a computing device, where the image may be captured or recorded. The term “screenshotting” and the phrase “being screenshotted” may refer to capturing or recording a screenshot. In some aspects, screenshotting may be performed using a screenshotting application (e.g., the Snipping Tool in Microsoft's Windows 11, an application accessed using a Print Screen key of a keyboard or keypad, or the like).

As used herein, the term “sensitive information” may refer to data that is intended for, or restricted to the use of, one or more users or entities. Sensitive information may represent data that is personal, private, confidential, privileged, secret, classified, or in need of protection. Examples of sensitive information may include financial data such as account numbers, credit card account numbers, checking account numbers, virtual card numbers, savings account numbers, account balances, credit card account balances, checking account balances, savings account balances, financial statements, bills, or invoices; personally identifiable information such as a name, address, phone number, social security number, or driver's license number; medical information such as a patient's medical history, a doctor's summary or diagnosis, or medical test results; academic information such as a student's grades or transcript; business information such as trade secrets, proprietary information, alpha product releases, or business strategy information; governmental information such as classified or secret information related to national security or defense); or data that is copyrighted, etc.

As used herein, the term “static information” or “static content” may refer to data that is fixed or stationary, or non-video data. For example, static information may represent text data (e.g., letters, numbers, symbols, metadata, or alt text) or image data (e.g., an image or graphic).

As used herein, the terms “image frame that is transparent” and “transparent image frame” refer to an image frame of a video, where the image frame is clear (e.g., see-through or invisible, from the perspective of a user viewing the image frame on a display screen), and does not depict or represent any sensitive information.

As used herein, the term “HTML page” may refer to a file that includes HTML, and that defines the structure and content of a webpage or website. An HTML element may represent a component of an HTML page, and may include, for example, a start tag, an end tag, a content element, or a reference to a content element (e.g., a link, hyperlink, address, or path to a content element). In some embodiments, an HTML element may include one or more HTML elements (e.g., nested HTML elements).

As used herein, the term “Cascading Style Sheet” (also referred to herein as “CSS”) may refer to a language used to describe the presentation (e.g., formatting, layout, sizing, positioning, coloring, etc.) of content of a webpage or website. A “CSS rule” may refer to a rule (or property) that is written in CSS and that, when applied, describes the presentation of content of a webpage or website. In some aspects, one or more CSS rules may be included in a CSS file (e.g., a file with the extension, “.css”), which may be referenced by an HTML page. One or more CSS rules may also be directly included in an HTML page.

As used herein, the term “application programming interface (API) request,” “API request,” or “API call” may refer to a message sent to an API system that asks the API system (or an API associated with the API system) to perform a service or provide information.

In the following description, embodiments will be described with reference to the accompanying drawings. As will be discussed in more detail below, various embodiments, methods, and systems for securing content of a portal (e.g., a webpage, a website, an application, or the like) are described.

In a first exemplary use case, a customer of a bank may use a computing device, such as a laptop, to obtain financial information. More specifically, the customer may use a browser presented on a display screen of the laptop to load a webpage that is associated with the bank, and on which the customer anticipates viewing the customer's checking account number. In some aspects, the checking account number may represent sensitive information. Sensitive information may refer to data that is intended for, or restricted to the use of, one or more users or entities (e.g., the customer and the bank).

As the webpage is loaded, the laptop may determine that the customer's checking account number represents sensitive information. Consequently, the laptop may transmit the checking account number and formatting information associated with the checking account number (e.g., the font in which the checking account number should be displayed on the webpage) to an application server associated with the bank, via an application programming interface system. The laptop may further receive, from the application programming interface system, a link to a video that includes an image frame (or video frame) representing the checking account number, where the video was generated by the application server. In some aspects, the checking account number may be represented in accordance with the formatting information, in the image frame. The video may be protected by a DRM technology, and be a single-frame looped video (or be configured to play the image frame in a loop). The laptop may then access (or receive or retrieve) the video using the link, and form, using a browser module, an HTML element including the video. In some aspects, the HTML element may be included in an HTML page that corresponds to (or represents) the webpage. Further, the HTML page, or any CSS rules or Javascript associated with the HTML page, may indicate where the video of the HTML element is to be presented (or injected) in the webpage on the display screen. The laptop may output the video of the HTML element along with a portion of the webpage, to the display screen. In some aspects, the video may be configured to be overlaid on the portion of the webpage (or on a background color of the webpage), such that the video may appear to the customer as being displayed in front of the portion of the webpage. In some aspects, the video may be configured to play on the display screen when the display screen is not being screenshared or screenshotted, based on the DRM technology. The video may also be configured to not play (or be blocked from playing) on the display screen when the display screen is being screenshared or screenshotted (e.g., with a social engineer or potential social engineer), based on the DRM technology. Unlike existing technologies that may protect only digital video, the DRM technology used to protect the customer's sensitive information may protect both the outputted video (a digital video) and static or non-video information (e.g., the customer's checking account number).

In a second exemplary use case, a customer of a bank may use a computing device, such as a desktop computer, to obtain financial information. More specifically, the customer may use a browser presented on a display screen of the desktop computer to load a webpage that is associated with the bank, and on which the customer anticipates viewing the customer's savings account balance. In some aspects, the savings account balance may represent sensitive information.

As the webpage is loaded, the desktop computer may determine that the desktop computer has received an HTML page that represents the webpage, but does not include the savings account balance. The desktop computer may further determine that the HTML page includes formatting information associated with the savings account balance (e.g., information regarding the background color on which the savings account balance should be presented on the webpage). In some embodiments, the desktop computer may be configured to receive sensitive information such as the savings account balance only when the sensitive information is represented in an image frame of a video that is protected by a DRM technology. In some embodiments, the desktop computer may transmit a request for the savings account balance, along with the formatting information, to an application server associated with the bank, via an application programming interface server. The desktop computer may further receive, from the application programming interface server, a link to a video including an image frame representing the savings account balance, where the video was generated by the application server. The savings account balance may be represented in accordance with the formatting information in the image frame. In some aspects, the video may be protected by a DRM technology and be configured to play the image frame in a loop.

The desktop computer may then access (or retrieve or receive) the video using the link, and form, using a browser module, an HTML element including the video. In some aspects, the HTML element may be included in the HTML page that represents the webpage. Further, the HTML page, or any CSS rules or Javascript associated with the HTML page, may indicate where the video of the HTML element should presented (or injected) in the webpage on the display screen. The desktop computer may output the video of the HTML element along with a portion of the webpage, to the display screen. In some aspects, the video may be configured to be overlaid on the portion of the webpage (or on a background color of the webpage), such that the video may appear to the customer as being displayed in front of the portion of the webpage on the display screen. In some aspects, the video may be configured to play on the display screen when the display screen is not being screenshared or screenshotted, based on the DRM technology. The video may also be configured to not play (or be blocked from playing) on the display screen when the display screen is being screenshared or screenshotted (e.g., with a social engineer or potential social engineer), based on the DRM technology.

In some aspects, because the desktop computer is configured to receive sensitive information such as the savings account balance only when the sensitive information is represented in an image frame of a DRM-protected video, a developer console or any Javascript associated with the browser module of the desktop computer may not be able to access the sensitive information. Accordingly, the sensitive information may be protected not only by the DRM technology, but also by the configuration of the desktop computer. Such enhanced security may help reduce the risk of the sensitive information being accessed by a social engineer.

While each of the first and second exemplary use cases above involves a webpage and sensitive information, it should be understood that techniques according to this disclosure may be adapted to any suitable type of program (e.g., a website, portal, application, browser extension, plugin, etc.) and data (e.g., static information, sensitive information, non-sensitive information, text data, image data, audio data, etc.), respectively. It should also be understood that the example above is illustrative only. The techniques and technologies of this disclosure may be adapted to any suitable activity.

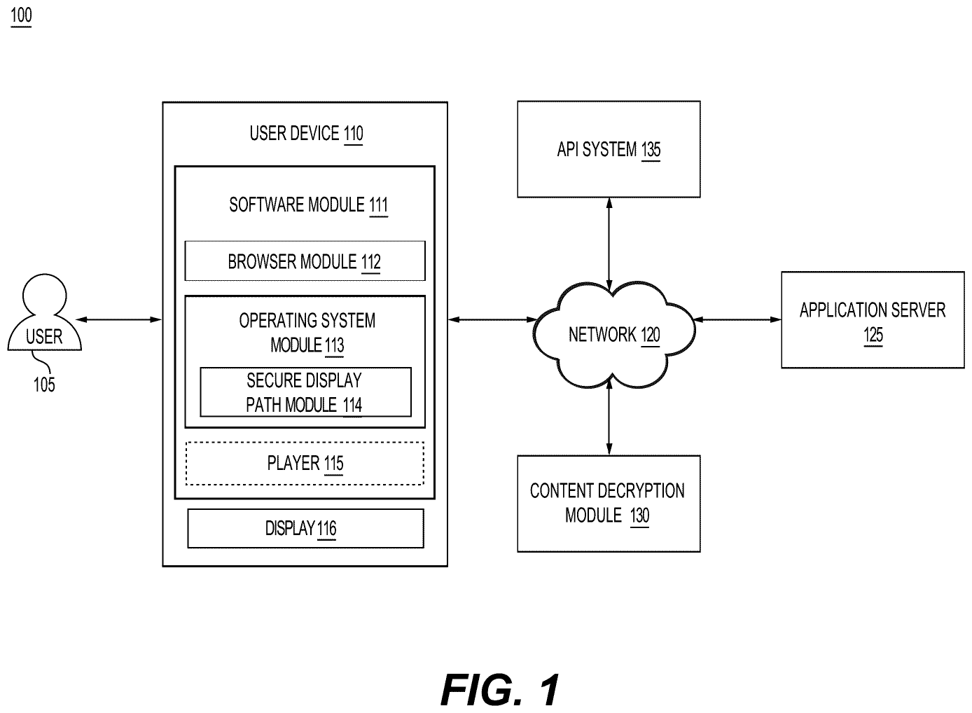

FIG. 1 depicts an example environment 100 that may be utilized with techniques presented herein. In some aspects, the environment 100 may be an embodiment of (i) the environment 100 described in U.S. Provisional Application 63/587,891, filed on Oct. 4, 2023, (ii) the environment 100 described in U.S. Provisional Application 63/665,485, filed on Jun. 28, 2024, (iii) the environment 100 described in U.S. Provisional Patent Application No. 63/683,063, filed Aug. 14, 2024, or (iv) the environment 100 described in U.S. Non-Provisional Application [Client Ref. IDF14709, attorney docket number 00212-0387-00000], filed Oct. 3, 2024, where each of these U.S. provisional applications is incorporated by reference herein in its entirety. As shown in FIG. 1, the environment 100 may include a user device 110, a network 120 (e.g., an electronic network), an application server 125, an application programming interface system 135 (also referred to herein as the “API system 135”), and a content decryption module 130 (also referred to herein as the “CDM 130”). In some aspects, the user device 110, the application server 125, the API system 135, and the CDM 130 may communicate with one another in any arrangement across the network 120. The user device 110 may be associated with a user 105. In some embodiments, the user 105 may be a customer or employee of, or contractor for, a company, business, or organization (e.g., a bank, a hospital, a university, etc.), or the like. Further, in some embodiments, the company, business, or organization may be associated with (e.g., own, rent, or control) the user device 110. In some other embodiments, the user 105 may own, rent, or control the user device 110. Further, in some embodiments, the user 105 may be an authorized user of the user device 110 and a portal accessed using the user device 110.

The user device 110 may be configured to enable the user 105 to access or interact with the network 120, the application server 125, the API system 135, and the CDM 130, in the environment 100. For example, the user device 110 may be a computer system such as a desktop computer, a laptop, a workstation, a mobile device, a tablet, etc. In some embodiments, the user device 110 may include one or more software modules, which may represent electronic application(s) such as a program, a platform, a plugin, or a browser extension, installed on a memory of the user device 110. For example, as shown in FIG. 1, the user device 110 may include a software module 111 that may represent (or include), for example, a browser module 112, an operating system module 113, and optionally a player 115. The player 115 may represent a video player configured to play back one or more videos, or present image frames (or video frames) of one or more videos on a display screen. In some embodiments, the player 115 may be included in the browser module 112 or the operating system module 113 (not shown in FIG. 1). In some other embodiments, the player 115 may represent hardware included in the user device 110 (not shown in FIG. 1). In some embodiments, the player 115 may represent an interactive video player, which is a video player configured to play back a video, where a user (e.g., the user 105) may interact with the video (e.g., by selecting a button presented in the video) during the playback on a display screen. The user device 110 may also optionally include a display 116, which may represent a display screen configured to display or present data (optionally using the player 115), where the data may be received from the browser module 112 or the operating system module 113.

The browser module 112 may include one or more browsers (e.g., web browsers or applications for accessing and viewing content on the internet, the World Wide Web, a cloud platform, etc.). In some embodiments, the browser module 112 may be configured to communicate with the operating system module 113, the display 116, the network 120, and the application server 125, the API system 135, and the CDM 130, via the network 120. For example, in response to the user 105 inputting a web address (or uniform resource locator) to the browser module 112 (e.g., using the display 116 or a keyboard or other input/output device associated with the user device 110), the browser module 112 may be configured to transmit a request for a webpage (or website, portal, application, etc.) associated with the web address, to the application server 125 via the network 120. The browser module 112 may also be configured to receive the webpage from the application server 125 via the network 120. In some aspects, the browser module 112 may be configured to load, render, or output the webpage (or a portion of the webpage) to the display 116 directly, or indirectly via the operating system module 113.

In some aspects, the webpage received by the browser module 112 from the application server 125 may include one or more content elements (or represent a single content element). In some aspects, a content element may represent data such as text data (e.g., letters, numbers, symbols, metadata, or alt text), image data (e.g., an image, a graphic, a sequence of image frames, or a video), or audio data (e.g., a sequence of audio frames). Further, in some aspects, a content element may include static information. As used herein, the term “static information” may refer to data that is fixed or stationary, or non-video data. For example, static information may represent text data (e.g., letters, numbers, symbols, metadata, or alt text) or image data (e.g., an image or graphic). In some embodiments, a content element may be dynamic (e.g., configured to change over time), such as an animated graphic or a video advertisement. Further, in some embodiments, a content element may be interactive (e.g., configured to respond to an input from a user of a computing device), such as a button, a toggle switch, a field configured to display text, a link (e.g., a hyperlink), an icon that may be selected to launch an application, text that may be highlighted or selected (e.g., using a cursor), or one or more images that may be highlighted or selected (e.g., using a cursor). In some aspects, a content element may include one or more content elements. Further, a content element may represent data included in, or referred by, an HTML element of an HTML page corresponding to (or representing) the webpage. An HTML element may represent a component of an HTML page, and may include, for example, a start tag, an end tag, and as noted above, a content element or a reference to a content element (e.g., a link, hyperlink, address, or path to a content element). Further, in some embodiments, an HTML element may include one or more HTML elements (e.g., nested HTML elements).

In some embodiments, one or more content elements of the webpage may include sensitive information or non-sensitive information. As explained above, sensitive information may refer to data that is intended for, or restricted to the use of, one or more users or entities (e.g., the user 105 and an organization associated with the application server 125). Moreover, sensitive information may represent data that is personal, private, confidential, privileged, secret, classified, or in need of protection. Sensitive information may further represent, for example, financial data such as account numbers, credit card account numbers, checking account numbers, savings account numbers, virtual card numbers, account balances, credit card account balances, checking account balances, savings account balances, financial statements, ledgers, bills, or invoices; personally identifiable information such as a name, address, phone number, social security number, or driver's license number; medical information such as a patient's medical history, a doctor's summary or diagnosis, or medical test results; academic information such as a student's grades or transcript; business information such as trade secrets, proprietary information, or business strategy information; governmental information such as classified or secret information related to national security or defense); or data that is copyrighted, etc. In some embodiments, the browser module 112 may be configured to determine whether one or more content elements of the webpage include sensitive information. The browser module 112 may also be configured to transmit this determination to the application server 125 via the network 120.

Further, in some embodiments, the browser module 112 may be configured to transmit an API request (or API call) to the API system 135, via the network 120. As used herein, the term “API request” or “API call” may refer to a message sent to the API system 135 that asks the API system 135 (or an API associated with the API system 135) to perform a service or provide information. In some embodiments, the API request may include or be associated with (i) one or more content elements of the webpage and (ii) a request that the API system 135 perform one or more actions (e.g., retrieve or forward one or more content elements, direct the application server 125 to retrieve one or more content elements, direct the application server 125 to generate or store a DRM-protected video that includes an image frame depicting one or more content elements, or transmit a link to the user device 110 (e.g., the browser module 112 or the operating system module 113), where the link is configured to direct the user device 110 to a DRM-protected video that includes an image frame depicting one or more content elements. For example, the browser module 112 may be configured to transmit, to the API system 135, an API request that includes (i) one or more content elements of the webpage that represent sensitive information, and (ii) one or more content elements of the webpage that represent formatting information associated with the sensitive information (e.g., metadata representing one or more of a size, background color, font, font size, position, or other formatting information, of the sensitive information). Such an API request may also include a request that the API system 135 forward (i) the one or more content elements of the webpage that represent the sensitive information, and (ii) the one or more content elements of the webpage that represent the formatting information associated with the sensitive information, to the application server 125.

As another example, the browser module 112 may be configured to transmit, to the API system 135, an API request that includes one or more content elements of the webpage, where the one or more content elements represent (i) a portion of an HTML page that corresponds to a portion of the webpage, (ii) one or more CSS rules associated with the portion of the HTML page, and (iii) Javascript associated with the portion of the HTML page. In some aspects, one or more of (i) the portion of the HTML page that corresponds to the portion of the webpage, (ii) the one or more CSS rules associated with the portion of the HTML page, and (iii) the Javascript associated with the portion of the HTML page, may represent or include sensitive information and formatting information associated with the sensitive information. The API request may also include a request that the API system 135 forward the one or more content elements of the webpage (or the portion of the webpage), to the application server 125.

As yet another example, the browser module 112 may be configured to transmit, to the API system 135, an API request that includes one or more content elements representing formatting information associated with sensitive information of the webpage (e.g., metadata representing one or more of a size, background color, font, font size, position, or other formatting information, of the sensitive information). Such an API request may also include a request that the API system 135 (i) retrieve one or more content elements including the sensitive information (e.g., a checking account number), and (ii) forward the retrieved one or more content elements, and the one or more content elements representing the formatting information, to the application server 125. Alternatively, the API request may also include a request that the API system 135 (i) direct the application server 125 to retrieve one or more content elements including the sensitive information (e.g., a checking account number), and (ii) forward the one or more content elements representing the formatting information, to the application server 125. In this example, the browser module 112 may be configured to receive sensitive information only when the sensitive information is depicted in an image frame of a DRM-protected video.

As another example, the browser module 112 may be configured to transmit, to the API system 135, an API request that includes one or more content elements of the webpage, where the one or more content elements represent (i) a portion of an HTML page corresponding to a portion of the webpage, (ii) one or more CSS rules associated with the portion of the HTML page, and (iii) Javascript associated with the portion of the HTML page. In some aspects, (i) the portion of the HTML page corresponding to the portion of the webpage, (ii) the one or more CSS rules associated with the portion of the HTML page, and (iii) the Javascript associated with the portion of the HTML page, may exclude sensitive information of the portion of the webpage. Further, in some aspects, one or more of (i) the portion of the HTML page corresponding to the portion of the webpage, (ii) the one or more CSS rules associated with the portion of the HTML page, or (iii) the Javascript associated with the portion of the HTML page, may include formatting information associated with the sensitive information of the portion of the webpage. For example, the portion of the HTML page corresponding to the portion of the webpage may include a tag indicating where the sensitive information should be inserted in the portion of HTML page. The API request may also include a request that the API system 135 (i) retrieve one or more content elements representing the sensitive information of the portion of the webpage, and (ii) forward the retrieved one or more content elements, and the one or more content elements representing the portion of the HTML page, the one or more CSS rules associated with the portion of the HTML page, and the Javascript associated with the portion of the HTML page, to the application server 125. Alternatively, the API request may also include a request that the API system 135 (i) direct the application server 125 to retrieve one or more content elements representing the sensitive information of the portion of the webpage, and (ii) forward the one or more content elements representing the portion of the HTML page, the one or more CSS rules associated with the portion of the HTML page, and the Javascript associated with the portion of the HTML page, to the application server 125. In this example, the browser module 112 may be configured to receive sensitive information only when the sensitive information is depicted in an image frame of a DRM-protected video.

In some embodiments, the browser module 112 may be configured to receive one or more content elements of the webpage from the application server 125, optionally via the CDM 130. For example, the browser module 112 may be configured to receive a DRM-protected video that includes an image frame depicting the one or more content elements of the webpage, from the application server 125 via the CDM 130. The browser module 112 may also be configured to communicate with the operating system module 113 (e.g., via a secure display path module 114). For example, the browser module 112 may be configured to transmit one or more content elements (e.g., a DRM-protected video or other data) to the operating system module 113 (e.g., via the secure display path module 114).

In some embodiments, the operating system module 113 may include one or more operating systems. In some aspects, an operating system may represent software configured to (i) manage hardware and software resources of the user device 110 or (ii) provide services for applications associated with the user device 110. In some embodiments, the operating system module 113 may include the secure display path module 114 (also referred to herein as the “secure display path 114”). In some aspects, the secure display path 114 may represent (or include) one or more DRM technologies (or DRM functions) used to protect or secure content element(s) that the secure display path 114 receives (or retrieves) from the browser module 112, the application server 125, the API system 135, or the CDM 130. The secure display path 114 may be native (or specific) to a respective operating system of the operating system module 113. In some embodiments, the secure display path 114 may represent Microsoft's Protected Media Path, for example.

In some aspects, the secure display path module 114 may be configured to load, render, or output to the display 116, one or more content elements of a webpage for presentation, optionally while the browser module 112 concurrently loads, renders, or outputs to the display 116, the remainder (or a portion of) of the webpage for presentation. For example, where a content element of a webpage represents a DRM-protected video and includes an image frame depicting sensitive information (e.g., a checking account balance), the secure display path module 114 may load, render, or output the DRM-protected video to the display 116 while the browser module 112 concurrently loads, renders, or outputs to the display 116, the remainder (or a portion) of the webpage (e.g., a portion of the webpage that excludes the DRM-protected video and the sensitive information). In some embodiments, the DRM-protected video may be presented over background color(s) of the remainder (or a portion) of the webpage, on the display 116. As another example, where a first content element of a webpage represents a DRM-protected video and includes an image frame that is transparent (and does not depict or represent sensitive information) and where a second content element of the webpage represents sensitive information (e.g., a checking account balance), the secure display path module 114 may load, render, or output the first and second content elements to the display 116, while the browser module 112 loads, renders, or outputs to the display 116, the remainder (or a portion) of the webpage. In some aspects, the first content element (the DRM-protected video) may be presented on top of (or be overlaid on) the second content element (the sensitive information) on the display 116, which may be overlaid on the remainder (or a portion) of the webpage. Further, when the first content element (the DRM-protected video) is played on the display 116 (e.g., when the transparent image frame of the DRM-protected video is played in a loop), the user 105 may view the second content element (the sensitive information) presented under the first content element (or the transparent image frame the DRM-protected video) on the display 116. As used herein, the terms “image frame that is transparent” and “transparent image frame” refer to an image frame of a video, where the image frame is clear (e.g., see-through or invisible, from the perspective of a user viewing the image frame on the display 116), and does not depict or represent any sensitive information.

In some aspects, the secure display path 114 may be configured to protect (or secure) one or more content elements by blocking or preventing the one or more content elements from being loaded, rendered, or output to or played on the display 116, when the display 116 is being screenshared (e.g., using a screensharing application or remote desktop application) or screenshotted (e.g., using a screenshotting application). For example, in some embodiments, the user 105 may view a DRM-protected video overlaid on a webpage on the display 116, and so long as the display 116 is not screenshared or screenshotted, the DRM-protected video may be played on the display 116. While the DRM-protected video is played, the user 105 may be able to see a content element (e.g., a credit card balance) that is either (i) represented in an image frame of the DRM-protected video or (ii) presented under a transparent image frame of the DRM-protected video. However, if the user 105 attempts to screenshare or take a screenshot of the display 116 with a social engineer (or potential social engineer), the secure display path 114 may cause the DRM-protected video to stop playing (or be blocked from playing) so that the social engineer (or potential social engineer) and the user 105 cannot see the content element.

The API system 135 may include a server or other computing device, and may be configured to interact with other systems, such as the user device 110, the application server 125, or the CDM 130, in the environment 100. The API system 135 may be configured to receive and respond to an API request (or API call), a request for information, or the like. For example, the API system 135 may be configured to receive one or more API requests from the user device 110 (e.g., the browser module 112 or the operating system module 113). As explained above, in some embodiments, an API request may include or be associated with (i) one or more content elements of the webpage and (ii) a request that the API system 135 perform one or more actions. The one or more actions may include, for example, retrieving one or more content elements that represent sensitive information (e.g., using the network 120), forwarding one or more content elements that include sensitive information or non-sensitive information to the application server 125, directing the application server 125 to retrieve one or more content elements representing sensitive information, directing the application server 125 to generate or store a DRM-protected video that includes an image frame depicting one or more content elements (e.g., representing sensitive information or non-sensitive information), or transmitting a link (e.g., a hyperlink) to the user device 110 (e.g., the browser module 112 or the operating system module 113), where the link is configured to direct the user device 110 to a DRM-protected video that includes an image frame depicting one or more content elements.

The application server 125 may be a computing system such as a server, a workstation, a desktop computer, a laptop, a mobile device, a tablet, etc. In some examples, the application server 125 may be associated with (or include) a cloud computing platform with scalable resources for computation or data storage. The application server 125 may run one or more applications locally or using the cloud computing platform, to perform various computer-implemented methods described in this disclosure. In some embodiments, the application server 125 may be associated with (e.g., owned, rented, or controlled by) a company, a business, or an organization, such as a bank, a hospital, a university, or a merchant, etc.

In some aspects, the application server 125 may be configured to communicate with the user device 110, the API system 135, and the CDM 130, via the network 120. For example, the application server 125 may be configured to transmit an HTML page (or file) corresponding to a webpage to the browser module 112 or the operating system module 113, via the network 120. In some embodiments, the application server 125 may be configured to receive a notification (or determination) from the browser module 112 that one or more content elements of the HTML page include sensitive information. Further, in some embodiments, the application server 125 may be configured to determine whether one or more content elements of the HTML page (or webpage) include sensitive information. In response to determining (or receiving a determination) that a content element includes sensitive information, the application server 125 may dynamically generate and encrypt a DRM-protected video that includes either (i) a transparent image frame configured to be presented over the sensitive information on the display 116 or (ii) an image frame that depicts or represents the sensitive information. In some aspects, the application server 125 may be configured to transmit the encrypted, DRM-protected video to the CDM 130 (which may decrypt the encrypted DRM-protected video and transmit the decrypted DRM-protected video to the user device 110).

In some aspects, the application server 125 may be configured to communicate with the API system 135, as explained above. For example, the application server may be configured to receive, from the API system 135 (or from the user device 110 via the API system 135), (i) one or more content elements of the webpage that represent sensitive information, and (ii) one or more content elements of the webpage that represent formatting information associated with the sensitive information (e.g., metadata representing one or more of a size, background color, font, font size, position, or other formatting information, of the sensitive information). The application server 125 may further be configured to generate a DRM-protected video that includes a single image frame, where the single image frame depicts the one or more content elements of the webpage that represent the sensitive information, and where the sensitive information is formatted in accordance with the one or more content elements of the webpage that represent the formatting information. In some aspects, the DRM-protected video may be encrypted and configured to play the single image frame in a loop on a display screen (e.g., the display 116). Further, in some embodiments, the application server 125 may be configured to store the DRM-protected video in a storage component of the application server 125, elsewhere on the network 120, on a cloud storage component, or at a location accessible by the user device 110.

As another example, the application server 125 may be configured to receive, from the API system 135 (or from the user device 110 via the API system 135), one or more content elements of the webpage, where the one or more content elements represent (i) a portion of an HTML page that corresponds to a portion of the webpage, (ii) one or more CSS rules associated with the portion of the HTML page, and (iii) Javascript associated with the portion of the HTML page. In some aspects, one or more of (i) the portion of the HTML page that corresponds to the portion of the webpage, (ii) the one or more CSS rules associated with the portion of the HTML page, and (iii) the Javascript associated with the portion of the HTML page, may represent or include sensitive information and formatting information associated with the sensitive information. In some embodiments, the application server 125 may be configured to render (or interpret) the received one or more content elements of the webpage (e.g., as a frame) using a headless browser. The application server 125 may also be configured to generate a DRM-protected video based on the rendering of the headless browser. The DRM-protected video may include a single image frame that depicts the sensitive information, where the sensitive information may be formatted in accordance with the received one or more content elements representing the formatting information. In some aspects, the DRM-protected video may be encrypted and configured to play the single image frame in a loop on a display screen (e.g., the display 116). Further, in some embodiments, the application server 125 may be configured to store the DRM-protected video in a storage component of the application server 125, elsewhere on the network 120, on a cloud storage component, or at a location accessible by the user device 110.

As yet another example, the application server 125 may be configured to receive, from the API system 135 (or from the user device 110 via the API system 135), one or more content elements representing formatting information associated with sensitive information of the webpage (e.g., metadata representing one or more of a size, background color, font, font size, position, or other formatting information, of the sensitive information). The application server 125 may also be configured to receive, from the API system 135 (or from the user device 110 via the API system 135) a request (or directive or instruction) to retrieve one or more content elements including the sensitive information. In response to receiving such a request, the application server 125 may retrieve the one or more content elements including the sensitive information (e.g., from a source of record, a storage component of the application server 125, or using the network 120). Upon retrieving the one or more content elements including the sensitive information, the application server 125 may generate a DRM-protected video including a single image frame that depicts the sensitive information, where the sensitive information is formatted in accordance with the received one or more content elements representing the formatting information. In some aspects, the DRM-protected video may be encrypted and configured to play the single image frame in a loop on a display screen (e.g., the display 116). Further, in some embodiments, the application server 125 may be configured to store the DRM-protected video in a storage component of the application server 125, elsewhere on the network 120, on a cloud storage component, or at a location accessible by the user device 110.

As another example, the application server 125 may be configured to receive, from the API system 135 (or from the user device 110 via the API system 135), one or more content elements of the webpage, where the one or more content elements represent (i) a portion of an HTML page corresponding to a portion of the webpage, (ii) one or more CSS rules associated with the portion of the HTML page, and (iii) Javascript associated with the portion of the HTML page. In some aspects, (i) the portion of the HTML page corresponding to the portion of the webpage, (ii) the one or more CSS rules associated with the portion of the HTML page, and (iii) the Javascript associated with the portion of the HTML page, may exclude sensitive information of the portion of the webpage. Further, in some aspects, one or more of (i) the portion of the HTML page corresponding to the portion of the webpage, (ii) the one or more CSS rules associated with the portion of the webpage, or (iii) the Javascript associated with the portion of the HTML page, may include formatting information associated with the sensitive information of the portion of the webpage. The application server 125 may also be configured to receive, from the API system 135 (or from the user device 110 via the API system 135) a request (or directive or instruction) to retrieve one or more content elements representing the sensitive information of the portion of the webpage.

In response to receiving such a request, the application server 125 may retrieve the one or more content elements representing the sensitive information of the portion of the webpage (e.g., from a source of record, a storage component of the application server 125, or using the network 120). Upon retrieving the one or more content elements representing the sensitive information of the portion of the webpage, the application server 125 may insert the retrieved one or more content elements into the received portion of the HTML page corresponding to the portion of the webpage. In some embodiments, the application server 125 may be configured to render (or interpret) the portion of the HTML page (including the sensitive information), the one or more CSS rules associated with the portion of the HTML page, and the Javascript associated with the portion of the HTML page, (e.g., as a frame) using a headless browser. The application server 125 may also be configured to generate a DRM-protected video that includes a single image frame based on the rendering of the headless browser. The single image frame may depict the sensitive information that is formatted in accordance with the received formatting information. In some aspects, the DRM-protected video may be encrypted and configured to play the single image frame in a loop on a display screen (e.g., the display 116). Further, in some embodiments, the application server 125 may be configured to store the DRM-protected video in a storage component of the application server 125, elsewhere on the network 120, on a cloud storage component, or at a location accessible by the user device 110.

In some aspects, the CDM 130 (or DRM platform 130) may be configured to communicate with the user device 110, the API system 135, and the application server 125, via the network 120. For example, the CDM 130 may be configured to receive an encrypted, DRM-protected video from the application server 125 (or elsewhere on the network 120). The CDM 130 may also be configured to decrypt the encrypted, DRM-protected video, and transmit the decrypted, DRM-protected video to the user device 110 (e.g., to the browser module 112 or the operating system module 113).

In various embodiments, the network 120 may be a wide area network (“WAN”), a local area network (“LAN”), personal area network (“PAN”), or the like. In some embodiments, network 120 may include the Internet, and support the transmission of information and data between various systems online. “Online” may mean connecting to or accessing source data or information from a location remote from other devices or networks coupled to the Internet. Alternatively, “online” may refer to connecting or accessing an electronic network (wired or wireless) via a mobile communications network or device. The Internet is a worldwide system of computer networks-a network of networks in which a party at one computer or other device connected to the network can obtain information from any other computer and communicate with parties of other computers or devices. The most widely used part of the Internet is the World Wide Web (often-abbreviated “WWW” or called “the Web”). A “website page,” “website,” or “webpage” generally encompasses a location, data store, or the like that is, for example, hosted or operated by a computer system so as to be accessible online, and that may include data configured to cause a program such as a browser to perform operations such as send, receive, or process data, generate a visual display or an interactive interface, or the like

Although depicted as separate components in FIG. 1, it should be understood that a component or portion of a component in the environment 100 may, in some embodiments, be integrated with or incorporated into one or more other components. For example, in some embodiments, at least a portion of the application server 125, the API system 135, or the CDM 130 may be integrated into the user device 110. In some embodiments, operations or aspects of one or more of the components discussed above may be distributed amongst one or more other components. Any suitable arrangement or integration of the various systems and devices of the environment 100 may be used. Further, in some embodiments, the environment 100 may include multiple user devices 110, multiple API systems 135, multiple application servers 125, or multiple CDMs 130.

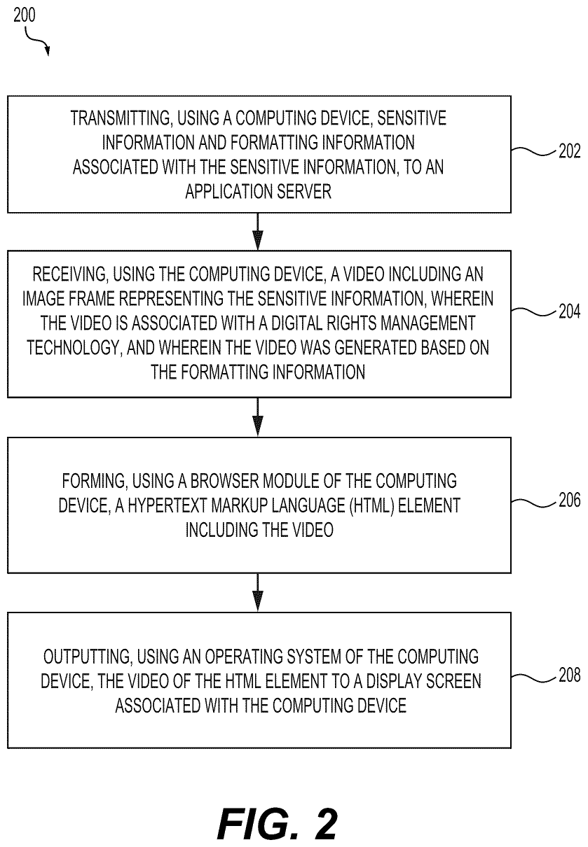

FIG. 2 is a flowchart illustrating a method 200 for securing content of a website (or a webpage, portal, etc.) according to one or more embodiments of the present disclosure. In some aspects, the method 200 may be performed by a computing device (e.g., the user device 110).

As shown in FIG. 2, the method 200 may include transmitting, using a computing device (e.g., the user device 110), sensitive information (e.g., a checking account number or other static information) and formatting information (e.g., a font) associated with the sensitive information, to an application server (e.g., the application server 125) (202). The method 200 may include receiving, using the computing device (and, for example, a link received from an API system such as the API system 135), a video including an image frame representing the sensitive information, where the video is associated with a DRM technology, and where the video was generated based on the formatting information (204). In some aspects, the video may have been generated by the application server. In some embodiments, the image frame representing the sensitive information may represent the only image frame included in the video. Further, the video may be protected by the DRM technology, and configured to play the image frame in a loop. The method 200 may include forming, using a browser module (e.g., the browser module 112) of the computing device, an HTML element including the video (206). In some embodiments, the HTML element may be included in an HTML page corresponding to (or representing) a webpage. The method 200 may include outputting, using an operating system (e.g., the operating system module 113) of the computing device, the video of the HTML element to a display screen (e.g., the display 116) associated with the computing device (208). In some embodiments, the method 200 may further including outputting, using the browser module of the computing device, a portion of the webpage to the display screen. The outputted video may be configured to be overlaid on (e.g., a background color of) the outputted portion of the webpage on the display screen.

In some aspects, because the outputted video may be protected by the DRM technology, the outputted video may be configured to (i) play on the display screen when the display screen is not being screenshared or screenshotted, and to (ii) not play (or be blocked from playing) on the display screen when the display screen is being screenshared or screenshotted (e.g., with a social engineer or potential social engineer). While existing DRM technologies are often used to protect only digital videos, the method 200 may use a DRM technology to protect static information.

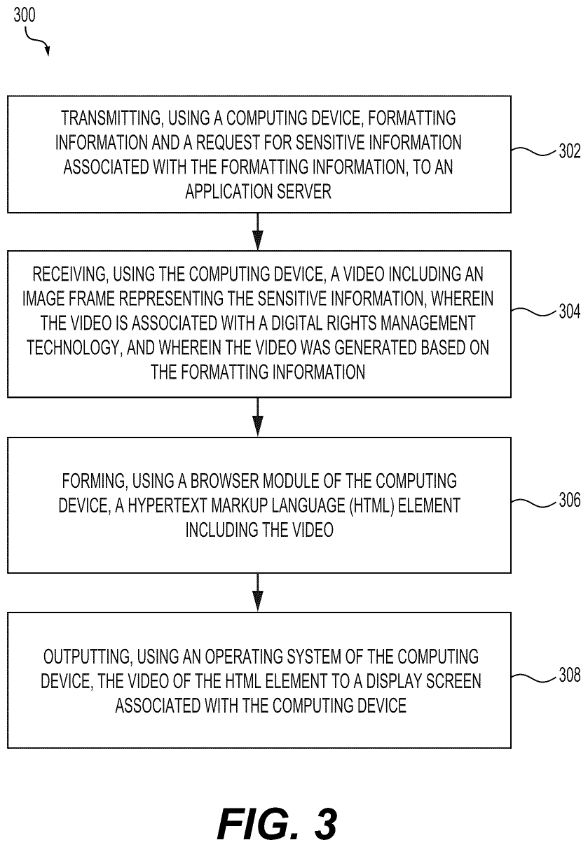

FIG. 3 is a flowchart illustrating a method 300 for securing content of a website (or a webpage, portal, etc.) according to one or more embodiments of the present disclosure. In some aspects, the method 300 may be performed by a computing device (e.g., the user device 110). Further, the method 300 may be an embodiment of the method 200 of FIG. 2.

As shown in FIG. 3, the method 300 may include transmitting, using a computing device (e.g., the user device 110), formatting information (e.g., a font) and a request for sensitive information (e.g., a checking account number) associated with the formatting information, to an application server (e.g., the application server 125) (302). The method 300 may include receiving, using the computing device (and, for example, a link received from an API system such as the API system 135), a video including an image frame representing the sensitive information, where the video is associated with a DRM technology, and where the video was generated based on the formatting information (304). In some aspects, the video may have been generated by the application server. In some embodiments, the image frame representing the sensitive information may represent the only image frame included in the video. Further, the video may be protected by the DRM technology, and configured to play the image frame in a loop. The method 300 may include forming, using a browser module (e.g., the browser module 112) of the computing device, an HTML element including the video (306). In some embodiments, the HTML element may be included in an HTML page corresponding to (or representing) a webpage. The method 300 may include outputting, using an operating system (e.g., the operating system module 113) of the computing device, the video of the HTML element to a display screen (e.g., the display 116) associated with the computing device (308). In some embodiments, the method 300 may further including outputting, using the browser module of the computing device, a portion of the webpage to the display screen. The outputted video may be configured to be overlaid on (e.g., a background color of) the outputted portion of the webpage on the display screen.

In some embodiments, the user device 110 may be configured to receive the sensitive information only when the sensitive information is included in an image frame of a DRM-protected video. As a result, the user device 110 (e.g., a developer console, or any Javascript, associated with the browser module 112) may have limited or no access with the sensitive information, thereby enhancing the security of the sensitive information.

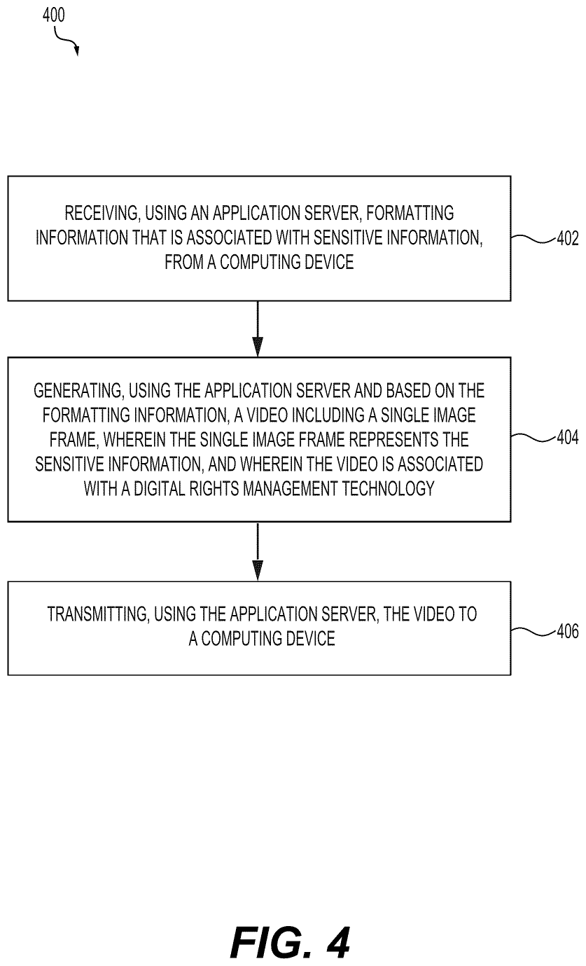

FIG. 4 is a flowchart illustrating a method 400 for securing content of a website (or a webpage, portal, etc.) according to one or more embodiments of the present disclosure. In some aspects, the method 400 may be performed by an application server (e.g., the application server 125). Further, the method 400 may be an embodiment of the method 200 of FIG. 2 or the method 300 of FIG. 3.

As shown in FIG. 4, the method 400 may include receiving, using an application server (e.g., the application server 125), formatting information (e.g., a font) that is associated with sensitive information (e.g., a checking account number), from a computing device (e.g., the user device 110) (402). In some embodiments, the application server may receive the formatting information that is associated with the sensitive information via an API system (e.g., the API system 135) and from the computing device. In some aspects, the sensitive information may represent static information. In some embodiments, the formatting information may represent metadata. Further, in some embodiments, the method 400 may include receiving, using the application server, the sensitive information from the computing device, via (or from) the API system, prior to generating the video. In some other embodiments, the method 400 may include receiving, using the application server, a request for the sensitive information from the computing device via the API system, and retrieving the sensitive information (e.g., from a source of record, a storage component, or the like).

In some embodiments, receiving, using the application server, the formatting information that is associated with the sensitive information, from the computing device, may include receiving, using the application server, a portion of a webpage from the computing device (e.g., via the API system), where the portion of the webpage includes a portion of an HTML page, one or more CSS rules, Javascript, and the formatting information.

The method 400 may include generating, using the application server and based on the formatting information, a video including a single image frame, where the single image frame represents the sensitive information, and where the video is associated with a DRM technology (404). In some embodiments, generating, using the application server, the video may be further based on the portion of the HTML page, the one or more CSS rules, the Javascript, and a headless browser. In some aspects, the video may be encrypted and configured to play the image frame in a loop. In some embodiments, the method 400 may further include storing, using the application server, the video in a storage component (e.g., of the application server 125, a cloud storage component of the network 120, or the like).

The method 400 may include transmitting, using the application server, the video to a computing device (406). In some embodiments, the application server may transmit the video to the computing device in response to the computing device selecting a link to the video. In some aspects, the video may be configured to play on a display screen (e.g., the display 116) associated with the computing device when the display screen is not being screenshared or screenshotted, based on the DRM technology. The video may also be configured to not play (or be blocked from playing) on the display screen when the display screen is being screenshared or screenshotted, based on the DRM technology.

In general, any process or operation discussed in this disclosure that is understood to be computer-implementable, such as the processes (or methods) illustrated in FIGS. 2, 3, and 4, may be performed by one or more processors of a computer system, such as any of the systems or devices in the environment 100 of FIG. 1, as described above. A process or process step performed by one or more processors may also be referred to as an operation. The one or more processors may be configured to perform such processes by having access to instructions (e.g., software or computer-readable code) that, when executed by the one or more processors, cause the one or more processors to perform the processes. The instructions may be stored in a memory of the computer system. A processor may be a central processing unit (CPU), a graphics processing unit (GPU), or any suitable types of processing unit.

A computer system, such as a system or device implementing a process or operation in the examples above, may include one or more computing devices, such as one or more of the systems or devices in FIG. 1. One or more processors of a computer system may be included in a single computing device or distributed among a plurality of computing devices. A memory of the computer system may include the respective memory of each computing device of the plurality of computing devices.

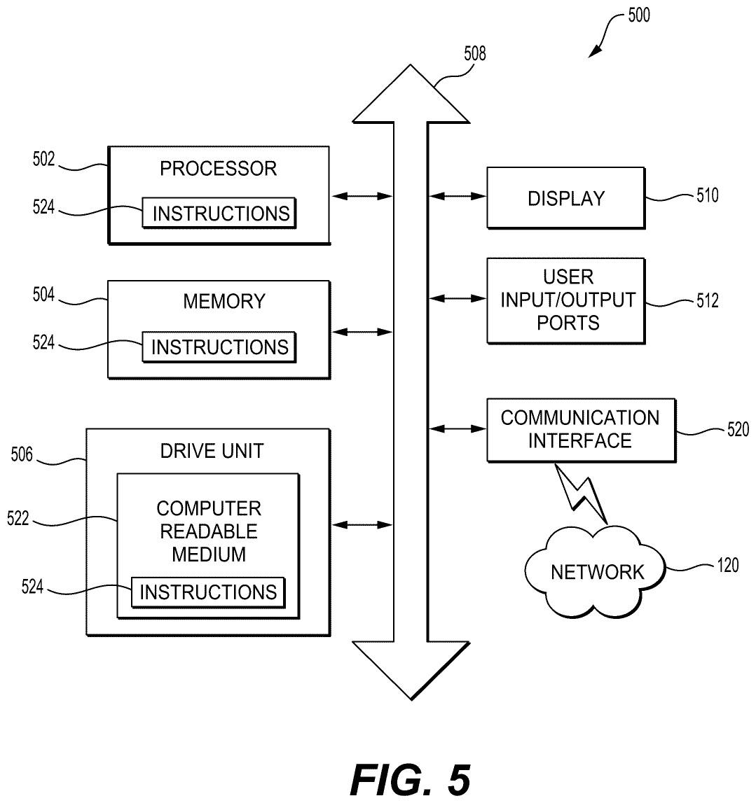

FIG. 5 is a simplified functional block diagram of a computer 500 that may be configured as a device for executing the methods of FIG. 2, 3, or 4, according to exemplary embodiments of the present disclosure. For example, in some embodiments, the computer 500 may be configured as the user device 110, according to exemplary embodiments of this disclosure. In some other embodiments, the computer 500 may be configured as the application server 125, according to exemplary embodiments of this disclosure. In some other embodiments, the computer 500 may be configured as the API system 135, according to exemplary embodiments of this disclosure. In some other embodiments, the computer 500 may be configured as the CDM 130, according to exemplary embodiments of this disclosure. In various embodiments, any of the devices or systems herein may be a computer 500 including, for example, a data communication interface 520 for packet data communication. The computer 500 also may include a central processing unit (“CPU”) 502, in the form of one or more processors, for executing program instructions. The computer 500 may include an internal communication bus 508, and a storage (or drive) unit 506 (such as ROM, HDD, SDD, etc.) that may store data on a computer readable medium 522, although the computer 500 may receive programming and data via network communications. The computer 500 may also have a memory 504 (such as RAM) storing instructions 524 for executing techniques presented herein, although the instructions 524 may be stored temporarily or permanently within other modules of computer 500 (e.g., processor 502 or computer readable medium 522). The computer 500 also may include input and output ports 512 or a display (or display screen) 510 to connect with input and output devices such as keyboards, mice, touchscreens, monitors, displays, etc. The various system functions may be implemented in a distributed fashion on a number of similar platforms, to distribute the processing load. Alternatively, the systems may be implemented by appropriate programming of one computer hardware platform.

Program aspects of the technology may be thought of as “products” or “articles of manufacture” typically in the form of executable code or associated data that is carried on or embodied in a type of machine-readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of the mobile communication network into the computer platform of a server or from a server to the mobile device. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

While the disclosed methods, devices, and systems are described with exemplary reference to transmitting data, it should be appreciated that the disclosed embodiments may be applicable to any environment, such as a desktop or laptop computer, etc. Also, the disclosed embodiments may be applicable to any type of Internet protocol.

It should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Thus, while certain embodiments have been described, those skilled in the art will recognize that other and further modifications may be made thereto without departing from the spirit of the invention, and it is intended to claim all such changes and modifications as falling within the scope of the invention. For example, functionality may be added or deleted from the block diagrams and operations may be interchanged among functional blocks. Steps may be added or deleted to methods described within the scope of the present invention.

The above disclosed subject matter is to be considered illustrative, and not restrictive, and the appended claims are intended to cover all such modifications, enhancements, and other implementations, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description. While various implementations of the disclosure have been described, it will be apparent to those of ordinary skill in the art that many more implementations are possible within the scope of the disclosure. Accordingly, the disclosure is not to be restricted except in light of the attached claims and their equivalents.

What is claimed is:

1. A method comprising:
receiving, using an application server, formatting information that is associated with sensitive information, from a computing device;
generating, using the application server and based on the formatting information, a video including a single image frame, wherein the single image frame represents the sensitive information, and wherein the video is associated with a digital rights management technology; and
transmitting, using the application server, the video to the computing device.

2. The method of claim 1, wherein receiving, using the application server, the formatting information that is associated with the sensitive information, from the computing device, comprises:
receiving, using the application server, the formatting information that is associated with the sensitive information, via an application programming interface system and from the computing device.

3. The method of claim 1, wherein the formatting information represents metadata.

4. The method of claim 1, wherein the formatting information represents metadata, and wherein the method further comprises:
receiving, using the application server, the sensitive information from the computing device, prior to generating the video.

5. The method of claim 1, further comprising:
receiving, using the application server, a request for the sensitive information from the computing device; and
retrieving the sensitive information.

6. The method of claim 1, further comprising:
receiving the sensitive information from an application programming interface system.

7. The method of claim 1, wherein receiving, using the application server, the formatting information that is associated with the sensitive information, from the computing device, comprises:
receiving, using the application server, a portion of a webpage from the computing device, wherein the portion of the webpage includes a portion of a HyperText Markup Language (HTML) page, one or more Cascading Style Sheet (CSS) rules, Javascript, and the formatting information.

8. The method of claim 7, wherein generating, using the application server, the video is further based on the portion of the HTML page, the one or more CSS rules, the Javascript, and a headless browser.

9. The method of claim 1, wherein the sensitive information represents static information.

10. The method of claim 1, wherein the video is encrypted and configured to play the image frame in a loop.

11. The method of claim 1, wherein the video is configured to not play on a display screen when the display screen is being screenshared or screenshotted, based on the digital rights management technology.

12. The method of claim 1, further comprising:
storing, using the application server, the video in a storage component.

13. A system comprising:
at least one processor; and
at least one memory having programming instructions stored thereon, which, when executed by the at least one processor, cause the system to perform operations comprising:
receiving, using an application server, formatting information that is associated with sensitive information;
generating, using the application server and based on the formatting information, a video including a single image frame, wherein the single image frame represents the sensitive information, and wherein the video is associated with a digital rights management technology; and
transmitting, using the application server, the video to a computing device.

14. The system of claim 13, wherein receiving, using the application server, the formatting information that is associated with the sensitive information, comprises:
receiving, using the application server, the formatting information that is associated with the sensitive information, via an application programming interface system and from the computing device.

15. The system of claim 13, wherein the formatting information represents metadata.

16. The system of claim 13, wherein the formatting information represents metadata, and wherein the operations further comprise:
receiving, using the application server, the sensitive information from the computing device, prior to generating the video.

17. The system of claim 13, wherein the operations further comprise:
receiving, using the application server, a request for the sensitive information from the computing device; and
retrieving the sensitive information.

18. The system of claim 13, wherein the operations further comprise:
receiving the sensitive information from an application programming interface system.

19. The system of claim 13, wherein receiving, using the application server, formatting information that is associated with the sensitive information, comprises:
receiving, using the application server, a portion of a webpage from the computing device, wherein the portion of the webpage includes a portion of a HyperText Markup Language (HTML) page, one or more Cascading Style Sheet (CSS) rules, Javascript, and the formatting information; and wherein generating, using the application server, the video is further based on the portion of the HTML page, the one or more CSS rules, the Javascript, and a headless browser.

20. A method comprising:
receiving, using an application server, formatting information that is associated with sensitive information, via an application programming interface and from a computing device;
generating, using the application server and based on the formatting information, a video including a single image frame, wherein the single image frame represents the sensitive information, and wherein the video is associated with a digital rights management technology; and
transmitting, using the application server, the video to the computing device.
